(19) United States
(12) Patent Application Publication
(10) Pub. No.: US 2006/0287816 A1
(43) Pub. Date: Dec. 21, 2006

(54) METHODS, SYSTEMS, AND COMPUTER PROGRAM PRODUCTS FOR INDICATING A RETURN ROUTE IN A MOBILE DEVICE

(76) Inventors: Jeffrey Scott Bardsley, Durham, NC (US); Richard Mark Horner, Cary, NC (US)

Correspondence Address: SCENERA RESEARCH, LLC, 111 CORNING RD., SUITE 220, CARY, NC, 27511, US

(21) Appl. No.: 11/160,296

(22) Filed: Jun. 17, 2005

(51) Int. Cl. G01C 21/34

(52) U.S. Cl. 701/209; 340/995.19

(57) ABSTRACT

Methods, systems, and computer program products are disclosed for indicating a return route in a mobile device. A location identifier representing an intermediate point along a route is received and is independent of global positioning system information. A direction of travel is associated with the location identifier. Directional instructions indicating a return route passing through the intermediate point are determined. The directional instructions are determined based on the location identifier and the associated direction of travel without reference to a mapping database and independent of global positioning system information. The directional instructions are then presented.

### TECHNICAL FIELD

The subject matter described herein relates to providing routing directions via a mobile device. More particularly, the subject matter described herein relates to indicating a return route in a mobile device.

### BACKGROUND

People often have difficulties navigating in unfamiliar areas. In some cases, it is not always initially evident whether a person will need assistance with navigation in an unfamiliar area until it is too late, such as when attempting to return to an initial point of origin. Maps are not always provided or readily available. Moreover, maps can be difficult to read and often make it hard for a person to orient themselves. In addition, it is difficult to provide maps for every possible path, especially when there are other factors that can change a person's choice of path. Construction, landscape changes, or other factors (rain, snow, etc.) can force a person to change their initially chosen path. Language barriers in reading signage and communicating with others also make navigation difficult. Even when a person is able to navigate successfully to a location, it is often difficult to navigate back following the return route to the point of origination.

Some of these concerns may be addressed with the use of devices operative in a global positioning system (GPS). Using GPS information, however, has several disadvantages. For example, GPS offers limited granularity and typically will not provide the accuracy needed for pedestrian navigation. In addition, GPS-enabled devices often rely on predefined mapping databases that may or may not be up-to-date. An outdated map of an area is more likely to confuse than assist a user. End users often have to subscribe to an update service to maintain updated mapping information. To get the mapping information, network connectivity is typically required, with valuable bandwidth being dedicated to downloading the new information. In addition, memory in the device must be dedicated to storing the mapping information. In some cases, the mapping information can be downloaded as-needed, which places the user at the mercy of connectivity and bandwidth availability. Further, GPS relies on a fixed coordinate system and is therefore not useful for finding locations when your surroundings are moving, such as on a cruise ship, airplane, train, etc.

Accordingly, there exists a need for methods, systems, and computer program products for indicating a return route in a mobile device without reference to a mapping database and independent of global positioning system information.

### SUMMARY

In one aspect of the subject matter disclosed herein, a method is disclosed for indicating a return route in a mobile device. A location identifier representing an intermediate point along a route is received and is independent of global positioning system information. A direction of travel is associated with the location identifier. Directional instructions indicating a return route passing through the intermediate point are determined. The directional instructions are determined based on the location identifier and the associated direction of travel without reference to a mapping database and independent of global positioning system information. The directional instructions are then presented.

In another aspect of the subject matter disclosed herein, a system is disclosed for indicating a return route in a mobile device. The system includes a location interface for receiving a location identifier representing an intermediate point along a route and a direction of travel associated with the location identifier, wherein the location identifier is independent of global positioning system information. The system also includes a memory for storing the location identifier and associated direction of travel, a processor for processing the location identifier and associated direction of travel to generate directional instructions indicating a return route passing through the intermediate point, and a user interface for presenting the directional instructions and for receiving user input. The return route is based on the location identifier and the direction of travel without reference to a mapping database and independent of global positioning system information.

In another aspect of the subject matter disclosed herein, a system is disclosed for indicating a return route in a mobile device. The system includes means for receiving a location identifier representing an intermediate point along a route, wherein the location identifier is independent of global positioning system information. The system also includes means for associating a direction of travel with the location identifier, means for determining directional instructions indicating a return route passing through the intermediate point, and means for presenting the directional instructions. The directional instructions are based on the location identifier and the associated direction of travel without reference to a mapping database and independent of global positioning system information.

In another aspect of the subject matter disclosed herein, a computer program product is disclosed. The computer program product includes computer executable instructions embodied in a computer-readable medium. The computer executable instructions are for performing steps including receiving a location identifier representing an intermediate point along a route, associating a direction of travel with the location identifier, determining directional instructions indicating a return route passing through the intermediate point, and presenting the directional instructions. The location identifier is independent of global positioning system information. The directional instructions are based on the location identifier and the associated direction of travel without reference to a mapping database and independent of global positioning system information.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a diagram illustrating a scenario in which the subject matter disclosed herein may be employed;

FIG. 2 is a block diagram illustrating a system for indicating a return route in a mobile device according to an aspect of the subject matter described herein; and

FIG. 3 is a flow diagram illustrating a method for indicating a return route in a mobile device according to another aspect of the subject matter disclosed herein.

### DETAILED DESCRIPTION

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Thus, the subject matter described herein can be embodied in many different forms, and all such forms are contemplated to be within the scope of what is claimed.

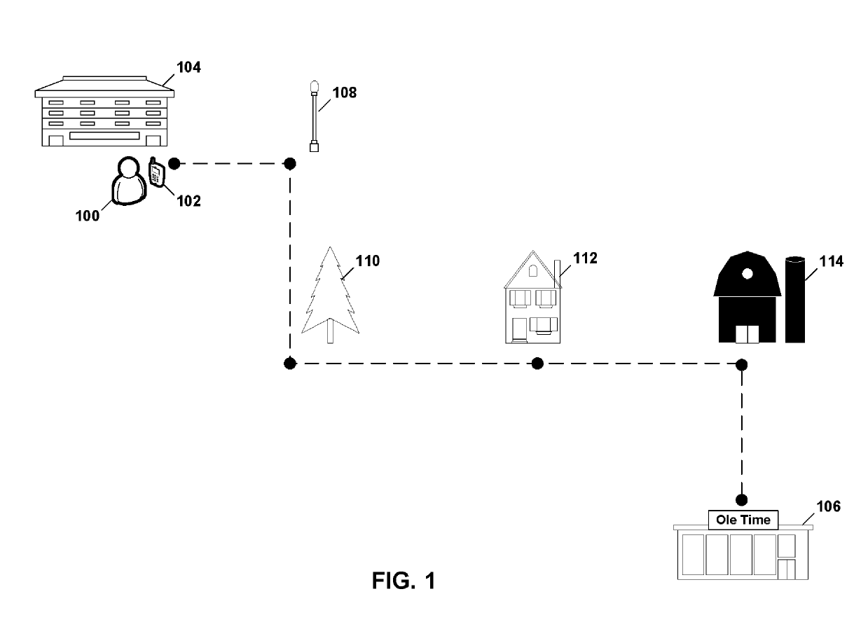

FIG. 1 is a diagram illustrating a scenario in which the subject matter disclosed herein may be employed. In FIG. 1, a user 100 is operating a mobile device 102. Mobile device 102 may be, for example, a mobile phone, a personal digital assistant, a laptop computer, a digital camera, a wristwatch, or any other portable electronic device that includes some or all of the functionality described herein. User 100 is staying in a hotel 104 in an unfamiliar city or town. User 100 leaves hotel 104 with plans to visit an area in town that contains several restaurants to have dinner at a restaurant 106. User 100, who is unfamiliar with the area, leaves hotel 104 with some directions he received from a hotel clerk.

User 100 departs hotel 104 carrying mobile device 102 and follows the route illustrated in FIG. 1, passing several intermediate points along the route, including a lamp post 108, a tree a 110, a house 112, and a barn 114, finally arriving at a restaurant 106 of choice. At each intermediate point along the route, a location identifier representing the intermediate point is recorded in mobile device 102 without the use of a global positioning system using techniques described further below. In addition, a direction of travel is associated with each intermediate point. Route data comprising the location identifiers and associated direction of travel may be recorded in a memory of device 102. Exemplary route data recorded for the forward trip from hotel 104 to restaurant 106 is shown below.

| Location Identifier | Direction of Travel |
|---|---|
| start | east |
| lamp post | right turn |
| large evergreen tree | left turn |
| green house | continue straight ahead |
| red barn | right turn |
| destination | |

When user 100 is ready to return to hotel 104, user 100 is presented with directional instructions indicating a return route passing through the intermediate points. The directional instructions are based on the location identifier and the associated direction of travel without reference to a mapping database and independent of global positioning system information. The return route is instead determined based on a translation of the forward route data shown above. Exemplary return route data recorded for the return trip from restaurant 106 to hotel 104 is shown below.

| Location Identifier | Direction of Travel |
|---|---|
| start | north |
| red barn | left turn |
| green house | continue straight ahead |
| large evergreen tree | right turn |
| lamp post | left turn |
| destination | |

As can be appreciated, the direction of travel may be absolute, e.g., north, south, east, and west, or may be relative based on a previous direction of travel, e.g., left turn, right turn, straight ahead. In addition, any other direction of travel indication may be used.

The return route data is generated in device 102 by processing the forward route data. In the example shown above, the order of location identifiers for intermediate points is reversed and the direction of travel is reversed where appropriate. As will be appreciated, according to other aspects of the subject matter disclosed, more sophisticated route data may be included in both the forward and return routes. For example, the distance traveled in each leg of the route may be determined using a pedometer component, inclines and declines may be determined using a clinometer component, and/or the time required to travel each leg of the route may be determined using a clock component, each being associated with mobile device 102.

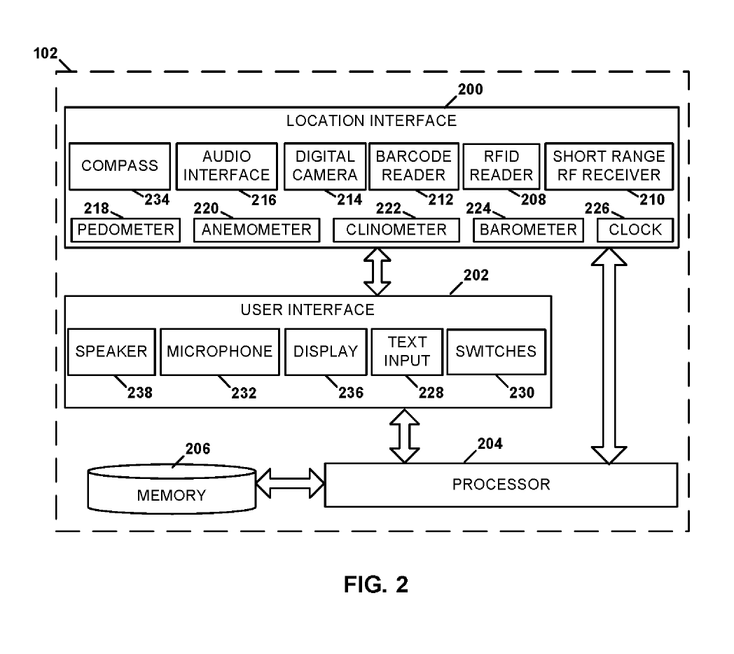

FIG. 2 is a block diagram illustrating a system for indicating a return route in a mobile device according to an aspect of the subject matter described herein. In FIG. 2, mobile device 102 includes a location interface 200, a user interface 202, a processor 204, and a memory 206. Mobile device 102 includes means for receiving a location identifier representing an intermediate point along a route and means for associating a direction of travel with the location identifier. For example, mobile device 102 includes location interface 200 for receiving a location identifier representing an intermediate point along a route and a direction of travel associated with the location identifier. The location identifier is independent of global positioning system information.

According to one aspect, location interface 200 may include a radio frequency identification (RFID) tag reader 208 for reading one or more RFID tags associated with the intermediate point. For example, lamp post 108 may include an RFID tag that is read by RFID reader 208. RFID reader 208 may be configured to read both passive and active RFID tags. To read passive RFID tags, RFID reader 208 may include a transceiver to transmit a signal to be received by a passive RFID tag and to receive a response to the transmitted signal. The passive RFID tag includes no internal power source and instead derives device power from the received signal to generate a response signal that includes the RFID tag identifier. To read active RFID tags (which contain an internal power source to power transmissions), RFID reader 208 may include a receiver that receives signals transmitted by active RFID tags within range. RFID reader 208 may be configured with a transceiver arranged to read both active and passive RFID's as described above.

The signal received from an RFID tag may include identifying information about the tag and/or information about the location. For example, the received signal may include only an identification number that uniquely identifies the tag to mobile device 102. Mobile device 102 may then correlate information about the location with the RFID tag identification number either by receiving user input via user interface 202 or by searching a database that correlates RFID tag identification numbers with location information. Alternatively, mobile device 102 may simply record the RFID tag identification number without additional information. In any case, the location identifier is associated with the RFID tag read by RFID reader 208.

According to another aspect, location interface 200 may include a short-range radio frequency (RF) receiver 210 configured to receive short-range radio frequency signals associated with the intermediate point. For example, according to one aspect, RF receiver 210 is configured to receive WiFi signals and/or Bluetooth signals. The location identifier is associated with the received signal. For example, a particular location may include a Bluetooth enabled device that may communicate with mobile device 102 via RF receiver 210 to provide the location identifier. Similarly, one or more WiFi signals may provide signals to identify a location. According to an aspect, the simultaneous receipt of two or more WiFi signals at a given location may be used to associate a location identifier with that location. For example, a mobile device 102 may be within range of three WiFi signals at a given street corner. The location identifier for that street corner may be the intersection of those three WiFi signals as received by RF receiver 210 in mobile device 102.

In another aspect, location interface 200 may include a barcode reader 212 for reading barcodes associated with the intermediate point. For example, with reference to FIG. 1, lamp post 108 may include a barcode that can be scanned by barcode reader 212 in location interface 200 of mobile device 102 to determine a location identifier.

According to another aspect, location interface 200 may include a digital camera 214 for capturing digital images associated with the intermediate point. The captured image may serve as a location identifier and may be included as part of the return route information. For example, with reference to FIG. 1, user 100 may capture a digital image of large evergreen tree 110 and associate a direction of travel with it. The captured digital image may then be included as part of the return route information.

In another aspect, location interface 200 may include an audio interface 216 for receiving an audio signal associated with the intermediate point. The audio signal may be an electrical signal representing an audio input at user interface 202, as will be described further below. The received audio signal may be processed and stored to represent the location identifier and/or the associated direction of travel.

According to another aspect, location interface 200 may be configured to receive distance traveled information associated with the intermediate point from a pedometer device 218. Pedometer device 218 may be part of mobile device 102 or may be located remotely and transmitting information to mobile device 102 via a transmission medium. With reference again to FIG. 1, pedometer 218 may be used to provide distance traveled information for each leg of the route. For example, the distance from lamp post 108 to large evergreen tree 110 may be determined and recorded alone or as part of the location identifier.

In other aspects, location interface 200 may be configured to receive information associated with the intermediate point from any one or more of a variety of devices, such as an anemometer 220, a clinometer 222, a barometer 224, and a clock 226. The respective devices may be part of mobile device 102 or may be located remotely and transmit information to mobile device 102 via a transmission medium. As will be appreciated, clock 226 may be used to determine a time of travel for one or more legs of the route, anemometer 220 may be used to measure wind force and velocity, clinometer 222 may be used to measure angles of elevation, slope, or incline, and/or barometer 224 may be used to measure atmospheric pressure. In each case, the measured information may be determined and recorded alone or as part of the location identifier.

According to another aspect, mobile device 102 also includes means for receiving user input. For example, user interface 202 includes a text input interface 228, such as a keyboard and/or a keypad. User interface 202 may also include other switches 230 for receiving a user input in for a variety of functions in mobile device 102, and may include a microphone 232 for receiving audio input such as speech and for converting the audio input to an electrical audio signal that is forwarded to audio interface 216 to be used as location identifier and/or direction of travel information.

In another aspect, location interface 200 may be configured to receive text input associated with the location identifier for the intermediate point from text input 228 of user interface 202. For example, a user can type in a description of a location, such as “large evergreen tree”. Microphone 232 may also be used to receive audio input that is later converted to text in audio interface 216 using speech recognition techniques known in the art.

Mobile device 102 also includes means for associating a direction of travel with the location identifier. For example, location interface 200 may be configured to receive the direction of travel associated with the location identifier by receiving text input via text input component 228 of user interface 202. Similar to the inputting of a location identifier described above, a user can type in a direction of travel, such as “right turn”. That is, text input component 228 may be used to determine location identifier and/or direction of travel information from a user 100 via text input via text input component 228. Similarly, microphone 232 may also be used to receive audio input that is later converted to text in audio interface 216 using speech recognition to determine direction of travel information.

According to another aspect, location interface 200 may be configured to receive the direction of travel associated with the location identifier by receiving an electrical audio signal from an audio input, such as microphone 232 of user interface 202, as described above.

In another aspect, location interface 200 may be configured to receive the direction of travel associated with the location identifier by receiving a compass signal indicating a direction of travel from a compass 234. Compass 234 may be part of mobile device 102 or may be located remotely and transmitting information to mobile device 102 via a transmission medium. Compass 234 may provide absolute directions, such as north, south, west, and east, and/or may provide changes in directions based on a previous direction of travel and a change in direction necessary, such as right turn, left turn, and straight ahead. Where absolute directions are provided by compass 234, changes in directions may be determined in processor 204 based on previous and new directions of travel.

According to another aspect, mobile device 102 includes means for determining directional instructions indicating a return route passing through the intermediate point. For example, processor 204 can process the location identifier and associated direction of travel to generate directional instructions indicating a return route passing through the intermediate point. Accordingly, the return route is based on the location identifier and the direction of travel without reference to a mapping database and is independent of global positioning system information. Each location identifier and associated direction of travel may be stored in memory 206 and retrieved for processing by a processor 204. Processor 204 translates the stored location identifier and associated directions of travel to provide a return route passing through the intermediate point or points. Here, the translation is performed by processor 204 based on the stored information and therefore does not require external global positioning system information or mapping database information.

In one aspect, processor 204 may be configured to determine directional instructions indicating a return route passing through the intermediate point by generating a text string that includes directional instructions for reversing the direction of travel at the intermediate point. For example, a text string is generated with directional instructions that reverse the order in which the location identifiers were input and reverses direction of travel as appropriate. For example, right turns are changed to left turns (and vice versa), north is changed to south, and so on.

According to another aspect, mobile device 102 includes means for presenting the directional instructions. For example, user interface 202 may include a display 236 and/or a speaker 238. Directional instructions may be presented to a user via display 236 in the form of a text file. Alternatively, or in addition, a digital image representing the intermediate point may be presented on display 236.

In another aspect, an audio file is generated that includes directional instructions for reversing the direction of travel at the intermediate point. The generated audio file is played for a user via speaker 238 of user interface 202.

According to another aspect, user interface 202 may be configured to receive a request to present directional instructions from a user. For example, a user may activate one off switches 230, may input text via text input component 228, and/or may issue an audio command via microphone 232 to request directional instructions indicating the return route.

It should be understood that the various components illustrated in FIG. 2 represent logical components that are configured to perform the functionality described herein and may be implemented in software, hardware, or a combination of the two. Moreover, some or all of these logical components may be combined or may be omitted altogether while still achieving the functionality described herein.

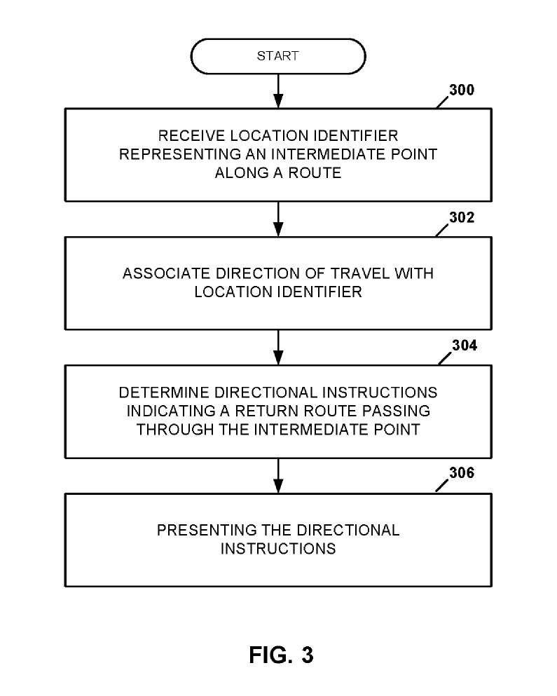

FIG. 3 is a flow diagram illustrating a method for indicating a return route in a mobile device according to another aspect of the subject matter disclosed herein. In block 300, a location identifier representing an intermediate point along a route is received. A direction of travel is associated with the location identifier in block 302. In block 304, directional instructions indicating a return route passing through the intermediate point are determined by processor 204. The directional instructions are presented in block 306.

Accordingly, the subject matter disclosed herein provides systems, methods, and computer program products for indicating a return route in a mobile device while avoiding the above-identified disadvantages associated with the use of a mapping database and of global positioning system information.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for indicating a return route in a mobile device, the method comprising:
at a mobile device:
receiving a location identifier representing an intermediate point along a route, wherein the location identifier is independent of global positioning system information;
associating a direction of travel with the location identifier;
determining directional instructions indicating a return route passing through the intermediate point, the directional instructions being determined based on the location identifier and the associated direction of travel without reference to a mapping database and independent of global positioning system information; and
presenting the directional instructions.

2. The method of claim 1 wherein receiving a location identifier representing an intermediate point along a route includes reading a radio frequency identification tag.

3. The method of claim 1 wherein receiving a location identifier representing an intermediate point along a route includes:
receiving at least one short-range radio frequency signal: and
associating the at least one short-range radio frequency signal with the intermediate point.

4. The method of claim 1 wherein receiving a location identifier representing an intermediate point along a route includes reading a bar code.

5. The method of claim 1 wherein receiving a location identifier representing an intermediate point along a route includes:
receiving a digital image from a camera; and
associating the digital image with the intermediate point.

6. The method of claim 1 wherein receiving a location identifier representing an intermediate point along a route includes:
receiving an audio signal from an audio input; and
associating the audio signal with the intermediate point.

7. The method of claim 1 wherein receiving a location identifier representing an intermediate point along a route includes:
receiving text input via a user interface; and
associating the text input with the intermediate point.

8. The method of claim 1 wherein receiving a location identifier representing an intermediate point along a route includes:
receiving distance traveled information from a pedometer device; and
associating the distance traveled information with the intermediate point.

9. The method of claim 1 wherein receiving a location identifier representing an intermediate point along a route includes information from at least one of an anemometer, a clinometer, a barometer, and a clock.

10. The method of claim 1 wherein associating a direction of travel with the location identifier includes receiving text input via a user interface of the mobile device.

11. The method of claim 1 wherein associating a direction of travel with the location identifier includes receiving an audio signal from an audio input.

12. The method of claim 1 wherein associating a direction of travel with the location identifier includes receiving a compass signal indicating a direction of travel.

13. The method of claim 1 wherein determining directional instructions indicating a return route passing through the intermediate point includes generating a text string that includes directional instructions for reversing the direction of travel at the intermediate point.

14. The method of claim 1 wherein determining directional instructions indicating a return route passing through the intermediate point includes generating an audio file that includes directional instructions for reversing the direction of travel at the intermediate point.

15. The method of claim 1 wherein determining directional instructions indicating a return route passing through the intermediate point includes associating a digital image representing the intermediate point with directional instructions for reversing the direction of travel at the intermediate point.

16. The method of claim 1 wherein presenting the directional instructions comprises:
receiving a request to present directional instructions from a user via a user interface of the mobile device; and
presenting the directional instructions via the user interface.

17. The method of claim 1 wherein presenting the directional instructions includes displaying the directional instructions on a display of the mobile device.

18. The method of claim 1 wherein presenting the directional instructions includes playing an audio file representing the directional instructions on a speaker of the mobile device.

19. A computer program product comprising computer executable instructions embodied in a computer-readable medium for performing steps comprising:
receiving a location identifier representing an intermediate point along a route, wherein the location identifier is independent of global positioning system information;
associating a direction of travel with the location identifier;
determining directional instructions indicating a return route passing through the intermediate point, the directional instructions being based on the location identifier and the associated direction of travel without reference to a mapping database and independent of global positioning system information; and
presenting the directional instructions.

20. A system for indicating a return route in a mobile device, the system comprising:
means for receiving a location identifier representing an intermediate point along a route, wherein the location identifier is independent of global positioning system information;
means for associating a direction of travel with the location identifier;
means for determining directional instructions indicating a return route passing through the intermediate point, the directional instructions being based on the location identifier and the associated direction of travel without reference to a mapping database and independent of global positioning system information; and
means for presenting the directional instructions.

21. A system for indicating a return route in a mobile device, the system comprising:
a location interface for receiving a location identifier representing an intermediate point along a route and a direction of travel associated with the location identifier, wherein the location identifier is independent of global positioning system information;
a memory for storing the location identifier and associated direction of travel;
a processor for processing the location identifier and associated direction of travel to generate directional instructions indicating a return route passing through the intermediate point, the return route being based on the location identifier and the direction of travel without reference to a mapping database and independent of global positioning system information; and
a user interface for presenting the directional instructions and for receiving user input.

22. The system of claim 21 wherein the location interface includes a radio frequency identification tag reader for reading radio frequency identification tags associated with the intermediate point.

23. The system of claim 21 wherein the location interface includes a receiver configured to receive short-range radio frequency signals associated with the intermediate point.

24. The system of claim 21 wherein the location interface includes a barcode reader for reading barcodes associated with the intermediate point.

25. The system of claim 21 wherein the location interface includes a digital camera for capturing digital images associated with the intermediate point.

26. The system of claim 21 wherein the location interface includes an audio interface for receiving an audio signal associated with the intermediate point.

27. The system of claim 21 wherein the location interface is configured to receive text input associated with the intermediate point from the user interface.

28. The system of claim 21 wherein the location interface is configured to receive distance traveled information associated with the intermediate point from a pedometer device.

29. The system of claim 21 wherein the location interface is configured to receive information associated with the intermediate point from at least one of an anemometer, a clinometer, a barometer, and a clock.

30. The system of claim 21 wherein the location interface is configured to receive the direction of travel associated with the location identifier by receiving text input via the user interface of the mobile device.

31. The system of claim 21 wherein the location interface is configured to receive the direction of travel associated with the location identifier by receiving an audio signal from an audio input.

32. The system of claim 21 wherein the location interface is configured to receive the direction of travel associated with the location identifier by receiving a compass signal indicating a direction of travel.

33. The system of claim 21 wherein the processor is configured to determine directional instructions indicating a return route passing through the intermediate point by generating a text string that includes directional instructions for reversing the direction of travel at the intermediate point.

34. The system of claim 21 wherein the processor is configured to determine directional instructions indicating a return route passing through the intermediate point by generating an audio file that includes directional instructions for reversing the direction of travel at the intermediate point.

35. The system of claim 21 wherein the processor is configured to determine directional instructions indicating a return route passing through the intermediate point by associating a digital image representing the intermediate point with directional instructions for reversing the direction of travel at the intermediate point.

36. The system of claim 21 wherein the user interface is configured to:
receive a request to present directional instructions from a user; and
present the directional instructions.

37. The system of claim 21 wherein the user interface is configured to present the directional instructions by displaying the directional instructions on a display of the mobile device.

38. The system of claim 21 wherein the user interface is configured to present the directional instructions by playing an audio file representing the directional instructions on a speaker of the mobile device.
